(19) United States
(12) Patent Application Publication
(10) Pub. No.: US 2005/0244077 A1
(43) Pub. Date: Nov. 3, 2005

(54) Method, apparatus and program for image processing

(75) Inventors: Yoshiro Kitamura, Kanagawa-Ken (JP); Tatsuya Aoyama, Kanagawa-Ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-Shi (JP)

(21) Appl. No.: 11/110,761

(22) Filed: Apr. 21, 2005

(30) Foreign Application Priority Data
Apr. 22, 2004 (JP) 126834/2004

(51) Int. Cl. G06K 9/40

(52) U.S. Cl. 382/261

(57) ABSTRACT

Appropriate deblurring is carried out on a partially blurry image. Edge detection means detects edges in 8 directions in a reduced image, and block division means divides the reduced image into 16 blocks. Analysis means analyzes images in the blocks based on edge characteristic quantities thereof, and judges whether each of the block images is a blurry image. The analysis means obtains a width of blur, a degree of shake, and a direction of blur in each of the blurry block images as blur information, and parameter setting means sets parameters for correction based on the blur information. The parameter setting means also sets a correction strength in such a manner that the strength becomes larger as the width of blur becomes larger, according to the width of blur in the blur information.

### BACKGROUND OF THE INVENTION

1. Field of the Invention

The present invention relates to an image processing method and an image processing apparatus for carrying out image processing such as deblurring on digital photograph images. The present invention also relates to a program for causing a computer to execute the image processing method.

2. Description of the Related Art

Digital photograph images are obtained by photography with a digital still camera (DSC) or by photoelectrically reading photograph images recorded on a photographic film such as a negative film and a reversal film with a reading device such as a scanner, and printed after having been subjected to various kinds of image processing thereon. Deblurring processing for correcting a blur in a blurry image is one type of such image processing.

As causes of blurry images are listed poor focus due to poor adjustment of focal length and shaking movement (hereinafter referred to as a shake) such as movement of a subject and camera shake caused by movement of hands of a photographer. In the case of poor focus, a point in a subject spreads two dimensionally in a photograph image. In other words, the spread occurs without a specific direction thereof in the corresponding image. On the other hand, in the case of shake, a point in a subject moves along a path and is smeared one dimensionally in a photograph image. In other words, the smear has directionality in the corresponding image.

In the field of digital photograph images, various kinds of methods have been proposed for correcting blurry images. If information on direction and length of shake can be obtained at the time of photography of an image, the image can be corrected by applying a restoration filter such as Wiener filter or an inverse filter to the image. Therefore, a method has been proposed in U.S. Patent Application Publication No. 20030002746, for example. In this method, a device (such as an acceleration sensor) enabling acquisition of information on the direction and length of shake at the time of photography is installed in an imaging device, and image restoration processing is carried out based on the information.

Another image restoration method is also known. In this method, a degradation function is set for a blurry image, and the blurry image is corrected by a restoration filter corresponding to the degradation function that has been set. The image after correction is then evaluated, and the degradation function is set again based on a result of the evaluation. This procedure of restoration, evaluation, and setting of the degradation function is repeated until a desired image quality can be achieved. However, this method is time-consuming, since the procedure needs to be carried out repeatedly. Therefore, in Japanese Unexamined Patent Publication No. 7(1995)-121703, a method has been described for improving processing efficiency. In this method, a user specifies a small area including an edge in a blurry image, and the procedure of restoration, evaluation, and setting of the degradation function is repeatedly carried out on the small area that has been specified, instead of the entire blurry image. In this manner, the degradation function is found optimally, and a restoration filter corresponding to the degradation function is then applied to the blurry image. In this manner, an amount of calculation is reduced by using the small area for finding the degradation function.

Meanwhile, following the rapid spread of mobile phones, functions thereof are improving. Especially, attention has been paid to improvement in functions of a digital camera embedded in a mobile phone (hereinafter simply called a phone camera). The number of pixels in a phone camera has reached 7 figures, and a phone camera is used in the same manner as an ordinary digital camera. Photography of one's favorite TV or sports personality with a phone camera has become as common as photography on a trip with friends. In a situation like this, photograph images obtained by photography with a phone camera are enjoyed by display thereof on a monitor of the phone camera and by printing thereof in the same manner as photograph images obtained by an ordinary digital camera.

However, since a mobile phone is not produced as a dedicated photography device, a mobile phone embedded with a digital camera is ergonomically unstable to hold at the time of photography. Furthermore, since a phone camera does not have a flash, a shutter speed is slower than an ordinary digital camera. For these reasons, when a subject is photographed by a phone camera, camera shake tends to occur more frequently than in the case of an ordinary camera. If camera shake is too conspicuous, the camera shake can be confirmed on a monitor of a phone camera. However, minor camera shake cannot be confirmed on a monitor, and becomes noticeable only after printing of an image. Therefore, deblurring processing is highly needed regarding a photograph image obtained by photography with a phone camera.

However, how to downsize mobile phones is one of key points in competition for manufacturers of mobile phones, in addition to performance and cost thereof. Therefore, installation of a device for obtaining information on direction and length of shake in a phone camera is not realistic. Therefore, the method in U.S. Patent Application Publication No. 20030002746 cannot be applied to a phone camera.

Furthermore, the method described in Japanese Unexamined Patent Publication No. 7(1995)-121703 needs specification of the small area by a user, which is troublesome. In addition, some photograph images may have shallow depth of field as in the case of close-up of face or may have been photographed when a subject or a part of a subject moved, or may have been obtained through follow shot for emphasizing liveliness. In such an image, only a part thereof is blurry. If the small area specified by a user falls on this blurry part, the degradation function cannot be found appropriately, leading to more degraded image quality after correction.

### SUMMARY OF THE INVENTION

The present invention has been conceived based on consideration of the above circumstances. An object of the present invention is therefore to provide a method, an apparatus, and a program for enabling efficient correction of a blur in a digital photograph image without a specific device installed in an imaging device and for carrying out appropriate correction on a partially blurry image such as an image having shallow depth of field.

An image processing method of the present invention is a method for deblurring a digital photograph image, and the method comprises the steps of:

obtaining blur information including a degree of blur in images in areas comprising the digital photograph image; and

carrying out deblurring processing on the images in the respective areas based on the blur information in such a manner that strength of the deblurring processing becomes stronger as the degree of blur becomes higher for the images of the respective areas.

The information on the degree of blur is information representing how a target image (the images in the areas comprising the digital photograph image, in this case) is blurry, and can be represented by a width of a blur, for example. In the case where an image is not blurry, the degree of blur is 0. As has been described above, a blur is caused by poor focus resulting in a blur without specific directionality and by a shake causing a blur in one direction. In the case of shake, the degree of blur is a degree of shake, and can be represented by length of shake, for example.

Causing the strength of the deblurring processing to become stronger for an image of higher degree of blur is equivalent to causing the strength of the deblurring processing to become weaker for an image of lower degree of blur. Consequently, for an image of an area in which the degree of blur is lower than a threshold value, the strength of the deblurring processing is 0 and the deblurring processing is not carried out in this case.

The phrase “the deblurring processing on the images of the respective areas is performed for each of the areas of the entire image” is not limited to cases in which deblurring processing is performed for each of the areas, based on the blur information regarding each of the areas, respectively. The deblurring processing may be performed for each of the areas of the entire image, based on blur information regarding one or a plurality of areas. Further, the deblurring processing may be performed for two or more areas, based on blur information regarding one or a plurality of areas.

In the image processing method of the present invention, when the degree of blur is found in the target image, an edge is detected in each of the images of the areas, and a characteristic quantity of the edge is obtained. Based on the characteristic quantity, the blur information can be obtained for the images of the respective areas.

As has been described above, since a blur causes a point in a blurry image to spread, an edge in a blurry image also spreads in accordance with the spread of point. In other words, how the edge spreads in the image is directly related to the blur in the image. The present invention pays attention to this fact, and the blur information can be found based on the characteristic quantity of the edge in each of the areas.

The characteristic quantity of the edge refers to a characteristic quantity related to how the edge spreads in the target image. For example, the characteristic quantity includes sharpness of the edge and distribution of sharpness of the edge.

The sharpness of the edge can be any parameter as long as the sharpness of the edge can be represented. For example, in the case of an edge represented by a profile shown in FIG. 3, the sharpness of the edge can be represented by an edge width so that a degree of sharpness becomes lower as the edge width becomes wider. Alternatively, the sharpness of the edge can be represented by a gradient of the profile so that the sharpness of the edge becomes higher as a change (the gradient of the profile) in lightness of the edge becomes sharper.

Furthermore, poor focus generates a blur without directionality and a shake generates a blur having directionality, as has been described above. Therefore, in order to appropriately. deblur, it is preferable for a blur to be corrected according to a direction of blur (any direction in the case of poor focus) by an isotropic filter working in any direction and by an anisotropic filter working only in the direction of blur (that is, the direction of shake). In the image processing method of the present invention, it is preferable for the edge to be detected in different directions in each of the images in the areas for finding the characteristic quantity of the edge in the respective directions. The degree of blur in the images in the areas and the direction of blur can be obtained as the blur information based on the characteristic quantity of the edge.

The different directions refer to directions used for finding the direction of blur in the target image. The directions need to include a direction close to the actual direction of blur. Therefore, the larger the number of the directions, the higher the accuracy of finding the direction becomes. However, in order to compensate for processing speed, it is preferable for the different directions to be set appropriately, such as 8 directions shown in FIG. 2, for example. In the present invention, in the case of poor focus, the direction of blur is any direction.

The width of blur representing the degree of blur refers to a width of blur in the direction of blur. For example, the width can be an average edge width in the direction of blur. In the case of poor focus resulting in a blur in any direction, the width may be an average edge width in any arbitrary direction. However, it is preferable for the width to be an average of edge widths in the different directions.

An image processing apparatus of the present invention is an apparatus for deblurring a digital photograph image, and the image processing apparatus comprises:

blur information acquisition means for obtaining blur information including a degree of blur in images in areas comprising the digital photograph image; and

correction execution means for carrying out deblurring processing on the images in the respective areas according to the blur information in such a manner that strength of the deblurring processing becomes stronger for the images of the areas in which the degree of blur is higher.

The blur information acquisition means may detect an edge in each of the images of the areas and obtain the blur information by finding a characteristic quantity of the edge.

It is preferable for the blur information to include a direction of blur. In this case, the blur information acquisition means preferably detects the edge in different directions in each of the images of the areas, and obtains the characteristic quantity of the edge in each of the directions. Based on the characteristic quantity in each of the directions, the blur information is obtained.

Note that the areas may be predetermined and partitioned within the entirety of the image. Alternatively, the areas may be partitioned, according to the sizes of objects, such as faces and eyes, within the image. As a further alternative, the areas may be partitioned at partitioning rates, according to the size of the image.

The image processing method of the present invention may be provided as a program for causing a computer to execute the image processing method.

According to the image processing method, the image processing apparatus, and the image processing program of the present invention, the blur information including the degree of blur is found by using the images of the areas comprising the digital photograph image, for deblurring the images in the areas. Therefore, a user does not need to specify an area, and a device is not necessary for obtaining information on shake at the time of photography. Therefore, an imaging device does not become larger in size, which is especially beneficial for a digital camera embedded in a mobile phone whose downsizing is keenly desired.

Furthermore, since the deblurring processing is carried out by increasing the strength thereof on the images in the areas in the digital photograph image according to an increase in the degree of blur therein, the deblurring processing can be carried out appropriately even on a partially blurry image such as a digital photograph image with shallow depth of field and a digital photograph image obtained by follow shot.

Note that the program of the present invention may be provided being recorded on a computer readable medium. Those who are skilled in the art would know that computer readable media are not limited to any specific type of device, and include, but are not limited to: CD's, RAM's ROM's, hard disks, magnetic tapes, and internet downloads, in which computer instructions can be stored and/or transmitted. Transmission of the computer instructions through a network or through wireless transmission means is also within the scope of this invention. Additionally, the computer instructions include, but are not limited to: source, object, and executable code, and can be in any language, including higher level languages, assembly language, and machine language.

### BRIEF DESCRIPTION OF THE DRAWINGS

FIG. 1 is a block diagram showing the configuration of an image processing apparatus of an embodiment of the present invention;

FIG. 2 shows directions used at the time of detecting an edge;

FIG. 3 shows an edge profile;

FIG. 4 is a histogram of edge width;

FIGS. 5A to 5C show operation of analysis means 20;

FIG. 6 shows calculation of a degree of blur;

FIGS. 7A to 7C show calculation of a degree of shake; and

FIG. 8 is a flow chart showing a procedure carried out by the image processing apparatus shown in FIG. 1.

### DESCRIPTION OF THE PREFERRED EMBODIMENT

Hereinafter, an embodiment of the present invention will be described with reference to the accompanying drawings.

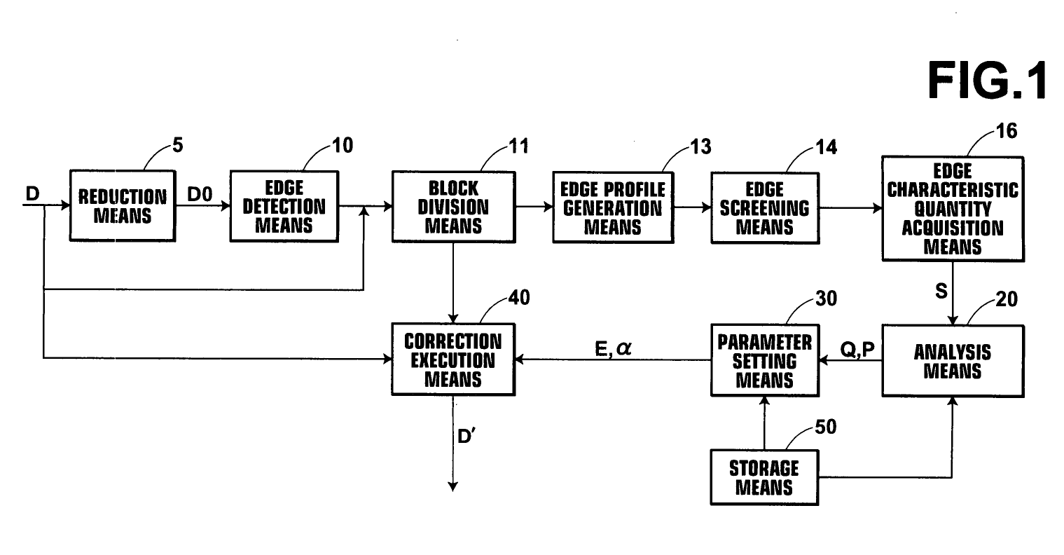

FIG. 1 is a block diagram showing the configuration of an image processing apparatus of an embodiment of the present invention. The image processing apparatus in this embodiment carries out deblurring processing on a digital photograph image that is input thereto, and is realized through execution of a deblurring program read out to a storage device by a computer (such as a personal computer). The deblurring program is stored in a recording medium such as a CD-ROM, or distributed via a network such as the Internet for installation in the computer.

Since image data represents an image, the image and the image data are hereinafter used in the same meaning.

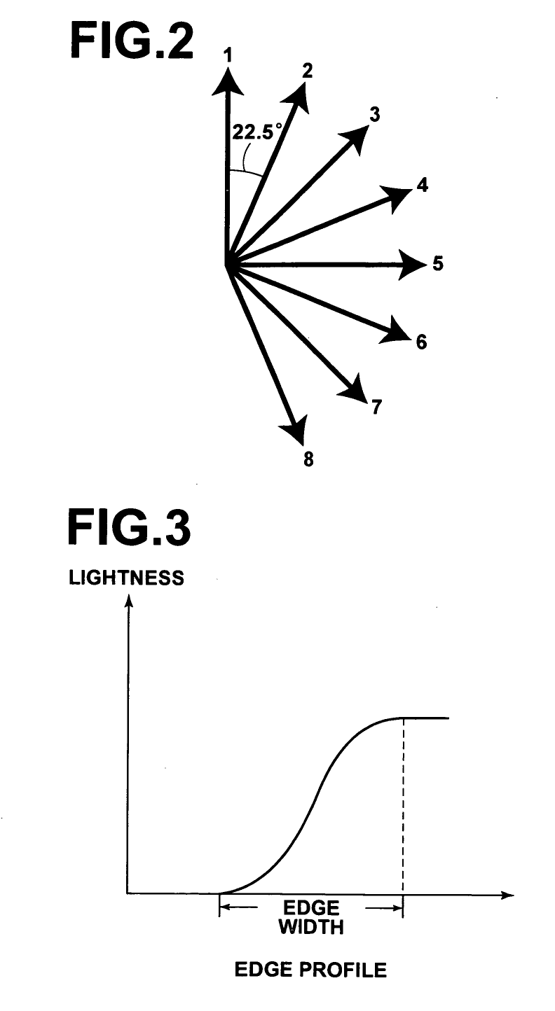

As shown in FIG. 1, the image processing apparatus in this embodiment comprises reduction means 5, edge detection means 10, block division means 11, edge profile generation means 13, edge screening means 14, characteristic quantity acquisition means 16, analysis means 20, parameter setting means 30, correction execution means 40, and storage means 50. The reduction means 5 obtains a reduced image D0 by carrying out reduction processing on an image D. The edge detection means 10 detects edges in each of the 8 directions shown in FIG. 2. The block division means 11 divides the reduced image D0 into 16 blocks, and outputs the edges detected by the edge detection means 10 in the respective blocks to the edge profile generation means 13. The edge profile generation means 13 generates a profile of each of the edges in each of the blocks (hereinafter referred to as an edge profile) input from the block division means 11. The edge screening means 14 eliminates an invalid part of the edges in each of the blocks. The characteristic quantity acquisition means 16 obtains characteristic quantities S of the edges obtained by the edge screening means 14 in each of the blocks. The analysis means 20 judges whether the image in each of the blocks is a non-blur image or a blurry image by calculating a direction of blur and a degree N of blur therein with reference to the characteristic quantities S thereof. In the case where the image is a non-blur image, the analysis means 20 sends information P representing the fact to the parameter setting means 30. In the case where the image is a blurry image, the analysis means 20 calculates a degree K and a width L of shake in the image and sends blur information Q including the degree K and the width L of the shake, and the direction of blur to the parameter setting means 30. The parameter setting means 30 sets parameters E and a correction strength α for carrying out the deblurring processing on the images based on the blur information Q input from the analysis means 20. The correction execution means 40 obtains a corrected image D′ by carrying out the deblurring processing on the images in the blocks in the image D by using the parameters E and the strength α. The storage means 50 has databases of various kinds for the parameter setting means 30.

The edge detection means 10 detects the edges of a predetermined strength or higher in the reduced image D0 in the 8 directions shown in FIG. 2, and outputs coordinates of the edges to the block division means 11.

The block division means 11 divides the edges detected by the edge detection means 10 into the 16 blocks obtained by division of the image D, and outputs the edges to the edge profile generation means 13. The edge profile generation means 13, the edge screening means 14, the edge characteristic quantity acquisition means 16, and the analysis means 20 respectively carry out processing for each of the blocks. Hereinafter, the image in any one of the blocks is referred to as a block image Db, and the processing will be described below for the block image Db.

The edge profile generation means 13 generates the edge profile, such as the profile shown in FIG. 3, for each of the edges in the block image Db input from the block division means 11, based on the coordinates of each of the edges in each of the directions. The edge profile generation means 13 sends the edge profiles to the edge screening means 14.

The edge screening means 14 eliminates the invalid edges such as an edge of complex profile shape and an edge including a light source (such as an edge with a predetermined lightness or brighter), based on the edge profiles of the block image Db input from the edge profile generation means 13, and outputs the edge profiles of the remaining edges to the edge characteristic quantity acquisition means 16.

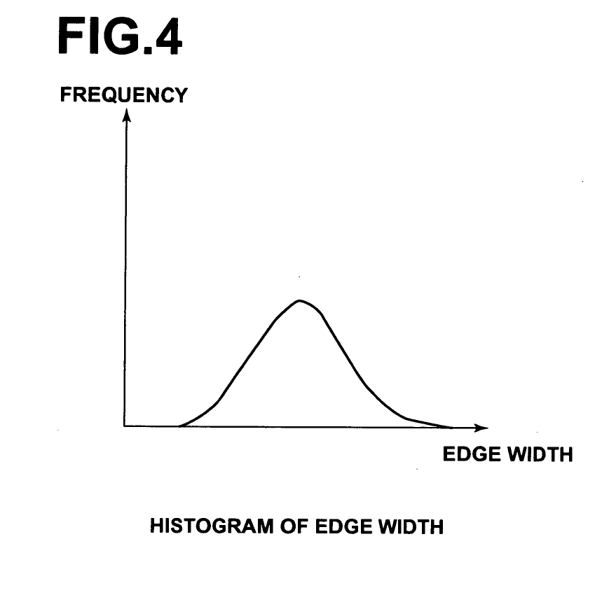

The edge characteristic quantity acquisition means 16 finds an edge width such as an edge width shown in FIG. 3, based on each of the edge profiles for the block image Db input from the edge screening means 14. The edge characteristic quantity acquisition means 16 generates histograms of the edge width, such as a histogram shown in FIG. 4, for the 8 directions shown in FIG. 2. The edge characteristic quantity acquisition means 16 outputs the histograms as the characteristic quantities S of the block image Db to the analysis means 20, together with the edge width.

The analysis means 20 mainly carries out two types of processing described below.

1. Judgment as to whether or not the block image Db is a non-blur image or a blurry image, based on the degree N and the direction of blur in the block image Db.

2. Calculation of the width L and the degree K of shake in the case of the block image Db being a blurry image.

The processing 1 will be described first.

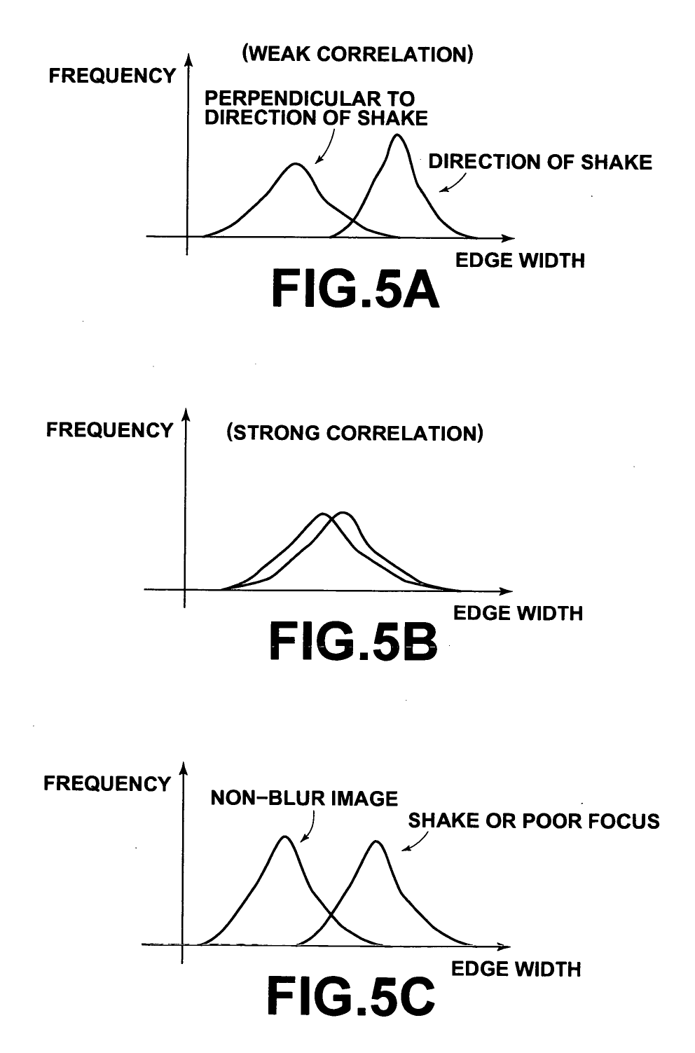

In order to find the direction of blur in the block image Db, the analysis means 20 finds a correlation value between the histograms of edge width in an orthogonal direction pair in the 8 directions shown in FIG. 2 (that is, in each of 4 pairs comprising directions 1 and 5, 2 and 6, 3 and 7, and 4 and 8). The correlation value may represent positive correlation or negative correlation. In other words, the larger the correlation value is, the stronger the correlation becomes in positive correlation. In negative correlation, the larger the correlation value is, the weaker the correlation becomes. In this embodiment, a value representing positive correlation is used. As shown in FIG. 5A, in the case where a shake is observed in an image, the correlation becomes weaker between the histogram in the direction of shake and the histogram in the direction perpendicular to the direction of shake. The correlation becomes stronger as shown in FIG. 5B between the histograms in the orthogonal direction pair including the directions other than the direction of shake and between the histograms in the orthogonal direction pair in the case of no shake in the image (that is, an image representing no shake or an image of poor focus). The analysis means 20 in the image processing apparatus of this embodiment pays attention to this trend, and finds the smallest value of correlation between the histograms among the 4 pairs of the directions. If the block image Db represents a shake, one of the two directions in the pair found as the pair of smallest correlation value represents the direction closest to the direction of shake.

FIG. 5C shows histograms of edge width in the direction of shake found from images of the same subject with a shake, poor focus, and no blur (without shake and without poor focus). As shown in FIG. 5C, the non-blur image has the smallest average edge width. In other words, one of the two directions having the larger average edge width in the pair represents the direction closest to the direction of shake.

The analysis means 20 finds the pair of weakest correlation, and determines the direction of the larger average edge width as the direction of blur.

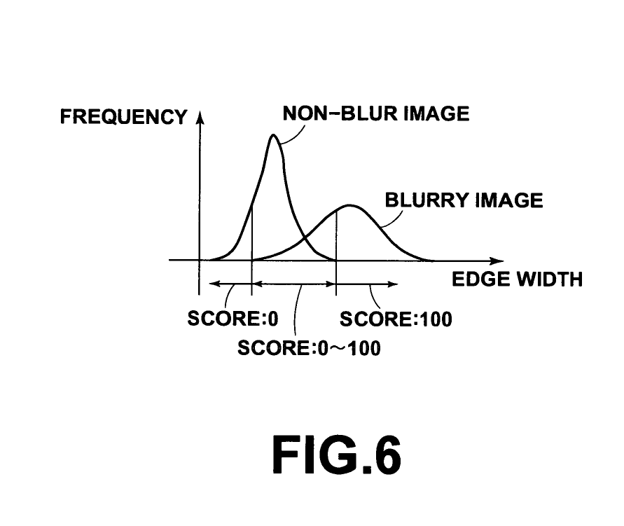

The analysis means 20 also finds the degree N of blur in the block image Db. The degree N represents the degree of how the image is blurry. The degree N may be found by using the average edge width in the blurriest direction (the direction of blur found in the above manner). However, in this embodiment, the degree N is found more accurately based on FIG. 6, by using the edge width in the direction of blur. In order to generate FIG. 6, histograms of edge width in the blurriest direction are generated, based on a non-blur image database and a blurry image (caused by shake and poor focus) database. In the case of non-blur images, although the blurriest direction is preferably used, an arbitrary direction may be used for generation of the histograms in FIG. 6. A score (an evaluation value) is found as a ratio of frequency of edge width (represented by the vertical axis) between blurry images and non-blur images. Based on FIG. 6, a database (hereinafter referred to as a score database) relating the edge width and the score is generated, and stored in the storage means 50.

The analysis means 20 refers to the score database stored in the storage means 50, and obtains the score of edge width regarding all the edges in the direction of blur in the block image Db. The analysis means 20 finds an average of the score of edge width in the direction of blur as the degree N of blur in the block image Db. In the case where the degree N for the block image Db is smaller than a predetermined threshold value T, the analysis means 20 judges that the block image Db is a non-blur image. In other words, the block image Db is judged to be an image without blur. Therefore, the analysis means 20 sends the information P representing the fact that the block image Db is a non-blur image to the parameter setting means 30.

In the case where the degree N of blur for the block image Db is not smaller than the threshold value T, the analysis means 20 judges that the block image Db is a blurry image, and carries out the processing 2 described above.

As the processing 2, the analysis means 20 finds the degree K of shake for the block image Db.

The degree K representing magnitude of shake in a blur can be found according to the following facts:

1. The smaller the value of correlation in the pair of the directions of weakest correlation (hereinafter referred to as the weakest correlation pair), the larger the degree of shake is.

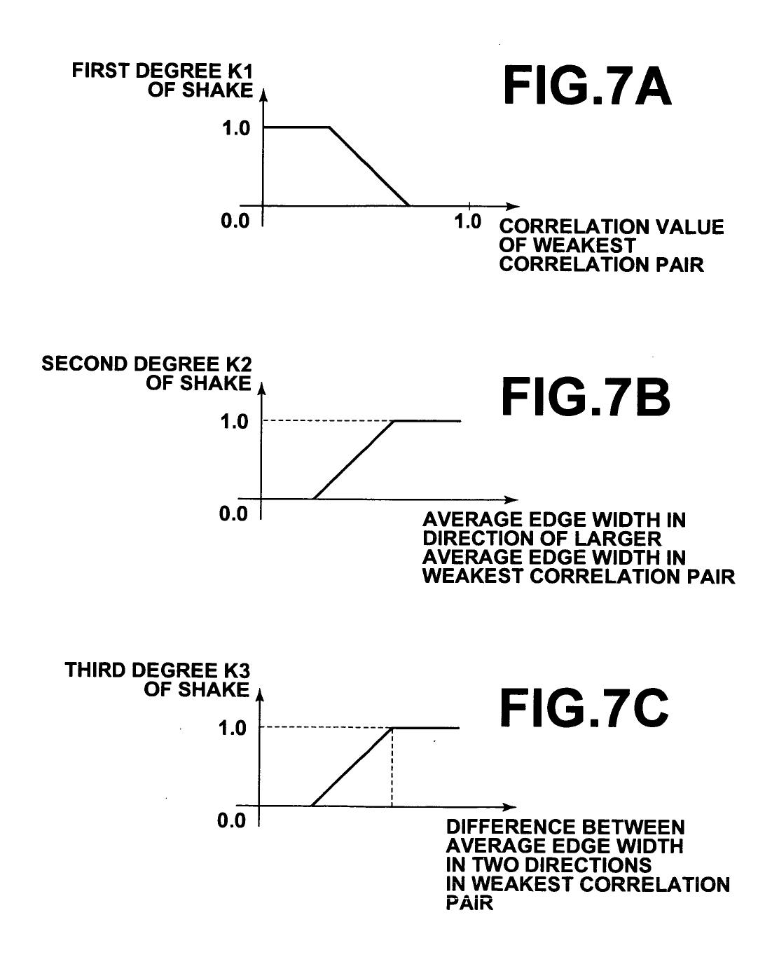

The analysis means 20 pays attention to this fact, and finds a first degree K1 of shake based on a graph shown in FIG. 7A. A lookup table (LUT) generated according to the graph shown in FIG. 7A is stored in the storage means 50, and the analysis means 20 reads the first degree K1 of shake corresponding to the value of correlation of the weakest correlation pair from the storage means 50.

2. The larger the average edge width in the direction of larger edge with in the weakest correction pair, the larger the degree of shake is.

The analysis means 20 pays attention to this fact, and finds a second degree K2 of shake based on a graph shown in FIG. 7B. A lookup table (LUT) generated according to the graph shown in FIG. 7B is stored in the storage means 50, and the analysis means 20 reads the second degree K2 of shake corresponding to the average edge width in the direction of larger edge width in the weakest correlation pair from the storage means 50.

3. The larger the difference in the average edge width in the two directions in the weakest correlation pair, the larger the degree of shake is.

The analysis means 20 pays attention to this fact, and finds a third degree K3 of shake based on a graph shown in FIG. 7C. A lookup table (LUT) generated according to the graph shown in FIG. 7C is stored in the storage means 50, and the analysis means 20 reads the third degree K3 of shake corresponding to the difference in the average edge width in the two directions in the weakest correlation pair from the storage means 50.

The analysis means 20 finds the degrees K1, K2 and K3 of shake in the above manner, and finds the degree K of shake for the block image Db according to the following Equation (1) using the degrees K1 to K3:
K=K1×K2×K3 (1)

The analysis means 20 then finds the width L of blur in the block image Db judged as a blurry image. The average edge width in the direction of blur may be found as the width L of blur, regardless of the degree K of shake. However, in this embodiment, the average edge width in the 8 directions shown in FIG. 2 is found as the width L of blur.

In this manner, the analysis means 20 finds the degree K of shake and the width L of blur for the block image Db judged as a blurry image, and outputs the degree K and the width L as the blur information Q to the parameter setting means 30, together with the direction of blur.

The parameter setting means 30 sets a one-directional correction parameter W1 for correcting directionality and a two-dimensional correction parameter W2 for isotropic correction, according to Equations (2) below:
W1=K×M1
W2=(1−K)×M2 (2)
where M1 and M2 are a one-dimensional correction mask and a two-dimensional correction mask, respectively.

In other words, the correction parameters W1 and W2 (hereinafter collectively called the parameters E) are set so that a weight for correction of directionality becomes larger as the degree K of shake becomes larger for the block image Db judged as a blurry image.

The parameter setting means 30 sets the correction strength α for the block image Db so that the strength becomes larger as the width L of blur becomes longer.

The parameter setting means 30 sets the parameters E and the correction strength α for the images in the respective blocks (16 blocks, in this case), and outputs the parameters E and the correction strength α to the correction execution means 40. For the block images having been judged as the images with no blur, that is, the block images regarding which the information P has been output from the analysis means 20, the correction parameters E are not set so that no correction is carried out thereon.

The correction execution means 40 deblurs the image D by emphasizing high-frequency components in the images in the respective blocks therein. More specifically, a blur in the block image Db is corrected by separating high-frequency components Dh in the block image Db and by emphasizing the high-frequency components Dh according to Equation (3) below by using the parameters E and the correction strength α that have been set by the parameter setting means 30:
Db′=Db+α×E×Dh (3)
where Db′ is a corrected block image.

Since the correction strength α is set larger as the width L becomes longer in the block image Db, the image (the block image Db judged as a blurry image) is corrected more strongly as the width L of blur becomes longer, as shown by Equation (3). The correction execution means 40 operates in such a manner that no correction is carried out on the block images regarding which the parameters E and the correction strength α have not been set.

The correction execution means 40 then combines the corrected block images and the block images with no blur, and generates the corrected image D′.

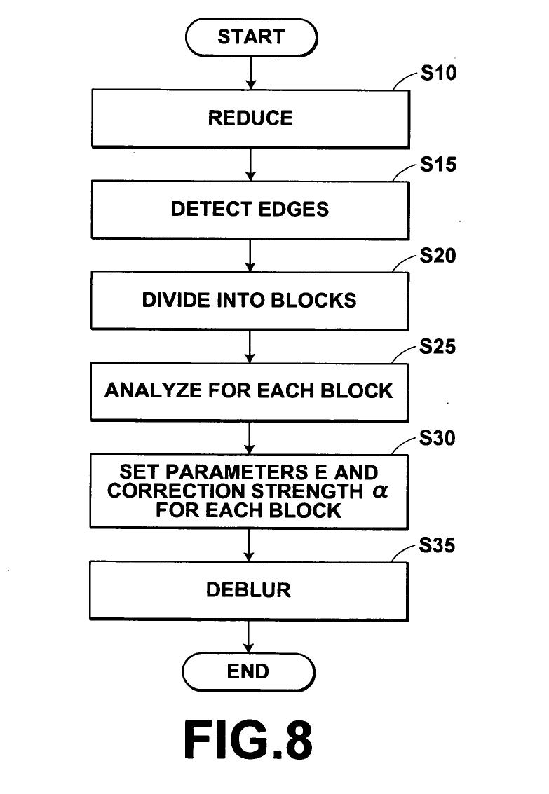

FIG. 8 is a flow chart showing a procedure carried out in the image processing apparatus in this embodiment. As shown in FIG. 8, the reduction means 5 carries out the reduction processing on the image D that have been input thereto, and obtains the reduced image D0 (S10). The edge detection means 10 detects in the reduced image D0 the edges in the 8 directions shown in FIG. 2. The edge detection means 10 obtains the coordinates of the detected edges (S15). The block division means 11 divides the reduced image D0 into the 16 blocks, and outputs the edges detected by the edge detection means 10 to the edge profile generation means 13 for each of the blocks (S20). The edge profile generation means 13, the edge screening means 14, the edge characteristic quantity acquisition means 16, and the analysis means 20 respectively carry out edge profile generation, edge screening by eliminating the invalid edges, acquisition of the edge characteristic quantities, and the analysis based on the edge characteristic quantities. Judgment is then made as to whether each of the block images is a non-blur image or a blurry image, and the blur information Q is obtained as the width L of blur, the degree K of shake, and the direction of blur for the block images as the blurry images (S25). The parameter setting means 30 sets the parameters E for the block images as the blurry images with reference to the blur information Q, and sets the correction strength a therefor in such a manner that the strength α becomes larger as the width L becomes longer for each of the block images (S30). The parameter setting means 30 does not set the parameters E and the correction strength α for the images that are not blurry. The correction execution means 40 obtains the corrected block images by correcting the block images corresponding to the parameters E and the correction strength α obtained by the parameter setting means 30, and combines the corrected block images with the block images regarding which the parameters have not been set by the parameter setting means 30. In this manner, the correction execution means 40 obtains the corrected image D′ (S35).

As has been described above, according to the image processing apparatus in this embodiment, a blur is corrected by obtaining the blur information from the digital photograph image. Therefore, a blur can be corrected without a special device used at the time of photography.

Furthermore, since the deblurring processing is carried out by setting the parameters based on the blur information, a procedure of parameter setting, correction, evaluation, and setting parameters again is not repeated, which is efficient.

In addition, since the deblurring processing is carried out in such a manner that the correction strength becomes stronger as the degree of blur (the width L in this case) in the image in each of the blocks comprising the image D becomes larger, the deblurring processing can be carried out appropriately even for a partially blurry image, such as an image of shallow depth of field, or an image of a subject moving at the time of photography, or an image obtained by follow shot.

Although the preferred embodiment of the present invention has been described above, the image processing method, the image processing apparatus, and the program therefor in the present invention are not necessarily limited to the embodiment described above. Various modifications can be made thereto within the scope of the present invention.

For example, the image processing apparatus in this embodiment divides the image D into the 16 blocks. However, the number of blocks may be different. The division of images is not limited to division into predetermined blocks. As an alternative, the image D may be divided into blocks according to the sizes of objects within the image D, such as faces and eyes. Furthermore, the image D may be divided according to a data size thereof. For example, in the case where the image D has 1 million pixels, the image D is divided into 16 blocks while the image D is divided into 32 blocks in the case where the image D has 2 million pixels.

The image processing apparatus in the above-described embodiment determines the direction of blur as the direction of larger average edge width in the two directions in the pair of weakest correlation. However, the degree of shake may be calculated for the weakest correlation pair and for the pair of second weakest correlation. In this case, the direction having the larger average edge width is determined as a candidate direction of blur, for each of the two pairs. Based on the degree of shake in the two pairs, the weight is set larger for the candidate direction whose degree of shake is larger. In this manner, the direction of blur can be obtained. In this case, the width of blur can also be obtained by setting the weight in such a manner that the weight of the average edge width becomes larger as the degree of shake becomes larger among the two candidate directions.

In the embodiment described above, the analysis means 20 finds the degree of shake for the images in the blocks having been judged as blurry images, without judging whether the blurry images have been caused by shake or poor focus. Thereafter, the analysis means 20 weights and adds the isotropic correction parameter and the directionality correction parameter by using the weights according to the degree of shake (the weight is the degree of shake, in this case). The image is then corrected by the parameters found in this manner. However, an image may be judged as an image of poor focus in the case where the degree of shake for the image is smaller than a predetermined threshold value. In this case, only the isotropic correction parameter may be set for correction of the image of poor focus.

The image processing apparatus shown in FIG. 1 divides the image into the blocks after edge detection is carried out on the image. However, the image may be divided first and the edge detection carried out thereafter.

In the embodiment described above, deblurring processing is performed on each block of the entire image D, based on the blur information regarding each block, respectively. However, the manner in which deblurring processing is performed on each block of the image D is not limited to that described in the above embodiment. The entire image may undergo deblurring processing, based on blur information regarding one or a plurality of blocks. For example, it may be estimated that the blur information regarding a single block represents the manner of blur for the entire image, and the entire image may be deblurred, based on the blur information. Alternatively, blur information may be obtained regarding two adjacent or two separated blocks. In the case that the blur information of the two blocks are identical, it may be estimated that the entire image is blurred in the same manner, and the entire image may be deblurred, based on the blur information. In the case that the blur information differs between the two blocks, it may be estimated that blur is distributed within the image, and the image may be deblurred at varying strengths across the entire image, employing the blur information as references.

In addition, it is also possible to perform deblurring processing on a plurality of blocks, based on the blur information regarding one or a plurality of blocks. For example, a Gaussian filter may be applied on blocks in the periphery of a block having a great degree of blur. Thereby, the degree of variance in the strengths of deblurring processing may be smoothed among adjacent pixels, and the degree of variance in the strengths of deblurring processing may be smoothed at the boundaries of the blocks.

The deblurring processing described above is not only applicable to camera phones and normal digital cameras, but may also be applied to printers for printing digital image data sets.

1. An image processing method for deblurring a digital photograph image, the image processing method comprising the steps of:
obtaining blur information including a degree of blur in images in areas comprising the digital photograph image; and
carrying out deblurring processing on the images of the respective areas based on the blur information in such a manner that strength of the deblurring processing becomes stronger for the images of the areas in which the degree of blur is higher.

2. The image processing method according to claim 1, wherein the step of obtaining the blur information comprises the steps of:
detecting an edge in each of the images of the areas;
obtaining a characteristic quantity of the edge; and
obtaining the blur information for the images of the respective areas, based on the characteristic quantity.

3. The image processing method according to claim 2, wherein the blur information includes a direction of blur, and the step of obtaining the blur information comprises the steps of:
detecting the edge in different directions in each of the images of the areas;
finding the characteristic quantity of the edge in each of the directions; and
obtaining the blur information for the images of the respective areas based on the characteristic quantity in each of the directions.

4. An image processing method as defined in claim 1, wherein:
the deblurring processing on the images of the respective areas is performed for each of the areas of the entire image, based on the blur information regarding each of the areas, respectively.

5. An image processing method as defined in claim 1, wherein:
the deblurring processing on the images of the respective areas is performed for the entire image, based on the blur information regarding at least one of the areas.

6. An image processing method as defined in claim 1, wherein:
the deblurring processing on the images of the respective areas is performed for a plurality of areas, based on the blur information regarding at least one of the areas.

7. An image processing method as defined in claim 1, wherein:
the deblurring processing of the images of the respective areas is not performed, in the case that one of the areas is not blurred.

8. An image processing apparatus for deblurring a digital photograph image, the image processing apparatus comprising:
blur information acquisition means for obtaining blur information including a degree of blur in images in areas comprising the digital photograph image; and
correction execution means for carrying out deblurring processing on the images of the respective areas according to the blur information in such a manner that strength of the deblurring processing becomes stronger for the images of the areas in which the degree of blur is higher.

9. The image processing apparatus according to claim 8, wherein
the blur information acquisition means detects an edge in each of the images of the areas,
finds a characteristic quantity of the edge, and
obtains the blur information for the images of the respective areas, based on the characteristic quantity.

10. The image processing apparatus according to claim 9, wherein
the blur information includes a direction of blur, and
the blur information acquisition means detects the edge in different directions in each of the images of the areas,
obtains the characteristic quantity of the edge in each of the directions, and
obtains the blur information for the images of the respective areas, based on the characteristic quantity in each of the directions.

11. An image processing apparatus as defined in claim 8, wherein:
the areas are predetermined and partitioned within the enti rety of the image.

12. An image processing apparatus as defined in claim 8, wherein:
the areas are partitioned, according to the sizes of objects within the image.

13. An image processing apparatus as defined in claim 8, wherein:
the areas are partitioned at partitioning rates, according to the size of the image.

14. A program for causing a computer to execute image processing for deblurring a digital photograph image, the image processing comprising the steps of:
blur information acquisition processing for obtaining blur information including a degree of blur in images in areas comprising the digital photograph image; and
deblurring processing on the images of the respective areas based on the blur information, the deblurring processing carried out in such a manner that strength of the deblurring processing becomes stronger for the images of the areas in which the degree of blur is higher.

15. The program according to claim 14, wherein the blur information acquisition processing comprises the steps of:
detecting an edge in each of the images of the areas;
obtaining a characteristic quantity of the edge; and
obtaining the blur information for the images of the respective areas, based on the characteristic quantity.

16. The program according to claim 15, wherein the blur information includes a direction of blur, and the blur information acquisition processing comprises the steps of:
detecting the edge in different directions in each of the images of the areas;
finding the characteristic quantity of the edge in each of the directions; and
obtaining the blur information for the images of the respective areas based on the characteristic quantity in each of the directions.

17. A computer readable medium having the program defined in claim 14 recorded therein.

18. A computer readable medium having the program defined in claim 15 recorded therein.

19. A computer readable medium having the program defined in claim 16 recorded therein.
